(19) United States
(12) Patent Application Publication
(10) Pub. No.: US 2018/0254974 A1
(43) Pub. Date: Sep. 6, 2018

(54) HIERARCHICAL GRAPH-BASED PATH SEARCH METHOD AND PATH SEARCH METHOD IN INTERNET OF THINGS ENVIRONMENT USING SAME

(71) Applicant: SAMJIN LND CO., LTD, Hwaseong-si (KR)

(72) Inventor: EunSeok SEO, Seoul (KR)

(21) Appl. No.: 15/757,347

(22) PCT Filed: Jul. 11, 2017
(86) PCT No.: PCT/KR2017/007423

§ 371 Date: Mar. 3, 2018

(30) Foreign Application Priority Data
Jul. 11, 2016 (KR) 10-2016-0087357

(51) Int. Cl. H04L 12/721; H04L 12/26; G06F 17/30

(52) U.S. Cl. CPC H04L 45/12; G06F 17/30958; G06F 17/30864; H04L 43/0805

(57) ABSTRACT

A hierarchical graph-based path search method includes: a first graph abstraction step of configuring a target space by a grid map and dividing the target space into regions to set a start vertex and a target vertex, and generating a first abstract graph by defining each vertex of the divided regions as a basic hub; a second graph abstraction step of defining vertices having a high degree centrality among vertices of each region of the first abstract graph as second basic hubs and generating a second abstract graph by connecting the second basic hubs; a graph search step of searching a shortest path between the start vertex and the target vertex in the second abstract graph; and a materialization step of projecting and materializing the path discovered in the graph search step onto the grid map.

### TECHNICAL FIELD

The present invention relates to a hierarchical graph-based path search method and a path search method in an Internet of Things (IoT) environment using the same, and more particularly, to a path search method capable of efficiently searching for a path in an IoT environment using a hierarchical graph-based path search method.

### BACKGROUND ART

Internet of Things (IoT) refers to a technique or environment that attaches sensors to things to transmit and receive data in real time. The IoT is a technique that has recently attracted attention because the IoT can provide a high level of service to users through context (context information) generation and context awareness.

The IoT can be roughly divided into two layers. One is an IoT layer including a plurality of IoT devices, and the other is a server layer connected to the IoT layer through a gateway. The components constituting the server layer (for example, a context-aware server, a control servers, etc.) have a higher level of computing performance than IoT devices. That is, it can be considered that the IoT device has a lower level of computing performance than the server layer. The IoT devices can be configured to have a high level of computing performance, but it is not cost-effective. Therefore, the IoT devices are typically configured to have a lower level of computing performance than the server layer.

In the IoT environment including the IoT layer and the server layer, the plurality of IoT devices constituting the IoT layer have a low level of computing performance. Therefore, it is necessary to perform a light computing operation in the IoT layer and a heavy computing operation in the server layer. That is, it is necessary to perform a low level of context generation and context awareness in the IoT layer and a high level of context generation and context awareness in the server layer.

The IoT can process a low level of context generation and context awareness in the IoT layer and a high level of context generation and context awareness in the server layer, so that data is efficiently processed to provide a high level of service to users.

For example, with the IoT, a dangerous situation can be early recognized and a fastest and safest optimal path for user evacuation or the like can be searched for and provided to users. A dangerous situation is early recognized in the IoT layer, and a fast and safe optimal path is searched for in the server layer having excellent computing performance, thereby efficiently processing data.

When such a dangerous situation is recognized, it is very important to search for an optimal path in real time and provide the optimal path to a user. That is, a user needs to be provided with an optimal path in real time so as to escape a dangerous situation as quickly as possible.

Among the search algorithms applied to environments requiring real-time properties and having limitation of computational resources, such as the IoT environment, A*, which is a representative algorithm of Cheapest-firstSearch (CFS), is widely used. The A* algorithm is an empirical search method based on a best-first search and performs search by using a cost of moving so far and an estimated cost from a current position to a target position.

The A* algorithm can apply various heuristics according to a method of developing a search region. In the case of performing a path search in a complicated and huge graph in real time, there is a problem that requires a high computational cost because almost all vertices are searched for.

Meanwhile, as a map abstraction-based path search method, there is a hierarchical map division method called Quadtrees. As for this method, a map is divided into square blocks, and each block is defined as a movable block and a non-movable block due to an obstacle. That is, when the movable block and the non-movable block are included in the divided region, the blocks are divided into a smaller size block to classify the movable block and the non-movable block. However, since this method always searches through the center of the block, there is a problem that the search cost increases.

If the conventional path search algorithm is applied to the environment requiring real-time properties and having limitation of computational resources, such as the IoT environment, the time cost is not minimized and much time is taken for path search. That is, if the path is searched for in the IoT environment to provide a shortest path to the user, much time is taken to provide the shortest path. In particular, when a dangerous situation such as an outbreak of fire, it is necessary to provide a user with the shortest path as soon as possible. However, applying the conventional path search algorithm to the IoT environment does not satisfy this necessity.

### DETAILED DESCRIPTION OF THE INVENTION

### Technical Problem

The present invention has been made in an effort to solve the above problems, and it is an object of the present invention to provide a hierarchical graph-based path search method capable of efficiently searching for an optimal path by minimizing time cost and to provide a path search method capable of efficiently searching for an optimal path by minimizing time cost even in an Internet of Things (IoT) environment by using the same.

### Technical Solution

According to an aspect of the present invention, a hierarchical graph-based path search method includes: a first graph abstraction step of configuring a target space by a grid map and dividing the target space into regions to set a start vertex and a target vertex, and generating a first abstract graph by defining each vertex of the divided region as a basic hub; a second graph abstraction step of defining vertices having a high degree centrality among vertices of each region of the first abstract graph as second basic hubs and generating a second abstract graph by connecting the second basic hubs; a graph search step of searching a shortest path between the start vertex and the target vertex in the second abstract graph; and a materialization step of projecting and materializing the path discovered in the graph search step onto the grid map.

In addition, the hierarchical graph-based path search method may further include, after the second graph abstraction step, an n-th graph abstraction step (where n is an integer of 3 or more) of defining vertex having high degree centrality among the vertices of each region of n-1 abstract graph as n-th basic hubs, and generating an n-th abstract graph by connecting the n-th basic hubs, wherein the graph search step sets a start vertex and a target vertex in the n-th abstract graph and searches for a shortest path between the start vertex and the target vertex.

In addition, a search for escaping an initial region in which the start vertex and the target vertex are located may be performed by searching for a shortest path with respect to the first abstract graph, and a search after escaping the corresponding region may be performed by searching for a shortest path with respect to the n-th abstract graph.

In addition, the hierarchical graph-based path search method may further include, before the graph search step, a verification step of verifying whether the start vertex and the target vertex are located in a mutually neighboring region, wherein, when the start vertex and the target vertex are located in the mutually neighboring region, a direct path between the start vertex and the target vertex is searched for.

In addition, the graph search step may include searching for a shortest path by using a predetermined algorithm, and the predetermined algorithm may be performed from the start vertex to the target vertex, and at the same time, the predetermined algorithm may be performed from the target vertex to the start vertex.

According to another aspect of the present invention, the IoT environment may include an IoT layer and a server layer, and the server layer may search for a shortest path by using the hierarchical graph-based path search method.

In addition, the path search method may include: a context information collection step of collecting, by an IoT layer, context information in a target space in real time and transmitting the collected context information to a server layer; a dangerous situation information generation step of determining, by the server layer, a current situation as a dangerous situation when the received context information or a combination of the received context information satisfies a predetermined condition, and generating dangerous situation information; a path search step of, when the dangerous situation information is generated, searching for a shortest path by using the hierarchical graph-based path search method; a shortest path transmission step of transmitting, by the server layer, the discovered shortest path to the IoT layer; and a path guide step of, when the IoT layer receives the shortest path, guiding the user to the shortest path by using devices constituting the IoT.

In addition, the path search method may further include, after the path guide step: a path re-search step of searching for a new shortest path when the server layer determines from the received context information that an obstacle occurs on the shortest path, and transmitting the newly discovered shortest path to the IoT layer; and a new shortest path guide step of guiding, by the IoT layer, a user to the new shortest path.

In addition, the IoT layer may include a lighting device, and the path guide step may include guiding the user to the shortest path by flickering or color change of the lighting device on the shortest path.

### Advantageous Effects

The hierarchical graph-based path search method according to the present invention can improve efficiency while minimizing time cost by abstracting a graph hierarchically and searching for a shortest path in the abstract graph.

In addition, the path search method in the Internet of Things (IoT) environment using the hierarchical graph-based path search method can also improve efficiency while minimizing time cost by abstracting a graph hierarchically and searching for a shortest path in the abstract graph, thereby guiding the user to the shortest path as soon as possible.

### DESCRIPTION OF THE DRAWINGS

FIG. 1 is a diagram illustrating a procedure of a hierarchical graph-based path search method according to an embodiment of the present invention.

FIGS. 2 and 3 are diagrams illustrating a first graph abstraction step according to an embodiment of the present invention.

FIG. 4 is a diagram illustrating a second graph abstraction step according to an embodiment of the present invention.

FIG. 5 is a diagram illustrating a search path and a region before applying ties-breaking in an A* algorithm.

FIG. 6 is a diagram illustrating a search path and a region after applying ties-breaking in an A* algorithm.

FIGS. 7 and 8 are diagrams illustrating a graph search step according to an embodiment of the present invention.

FIG. 9 is a diagram illustrating a procedure of a hierarchical graph-based path search method according to another embodiment of the present invention.

FIG. 10 is a diagram illustrating a procedure of a path search method in an Internet of Things (IoT) environment by using the hierarchical graph-based path search method according to the present invention.

### BEST MODE

In the following detailed description of the present invention, references are made to the accompanying drawings that show, by way of illustration, specific embodiments in which the present invention may be implemented. These embodiments are described in sufficient detail to enable those skilled in the art to implement the present invention. It should be understood that various embodiments of the present invention, although different, are not necessarily mutually exclusive. For example, specific features, structures, and characteristics described herein, in connection with one embodiment, may be implemented within other embodiments without departing from the spirit and scope of the present invention. In addition, it should be understood that the location or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range equivalent to what the claims claim. In the drawings, like reference numbers refer to the same or similar function through many ways.

It will be understood that although the terms “first,” “second,” etc. may be used herein to describe various components, these components should not be limited by these terms. These components are only used to distinguish one component from another. For example, a first component may be named a second component without departing from the scope of the inventive concept. Similarly, a second component may be named a first component.

The terminology used herein is for the purpose of describing particular embodiments only and is not intended to limit the present invention. As used herein, the singular forms “a,” “an” and “the” are intended to include the plural forms as well, unless the context clearly indicates otherwise. It will be understood that the terms “comprise,” “include,” and “have” used herein specify the presence of stated features, integers, steps, operations, elements, components, or combinations thereof, but do not preclude the presence or addition of one or more other features, integers, steps, operations, elements, components, or combinations thereof.

Unless otherwise defined, all terms including technical and scientific terms used herein have the same meaning as commonly understood by those of ordinary skill in the art to which the inventive concept belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

Hereinafter, embodiments will be described in detail with reference to the accompanying drawings. The following embodiments are provided so that this disclosure will be thorough and complete and will fully convey the present invention to those of ordinary skill in the art.

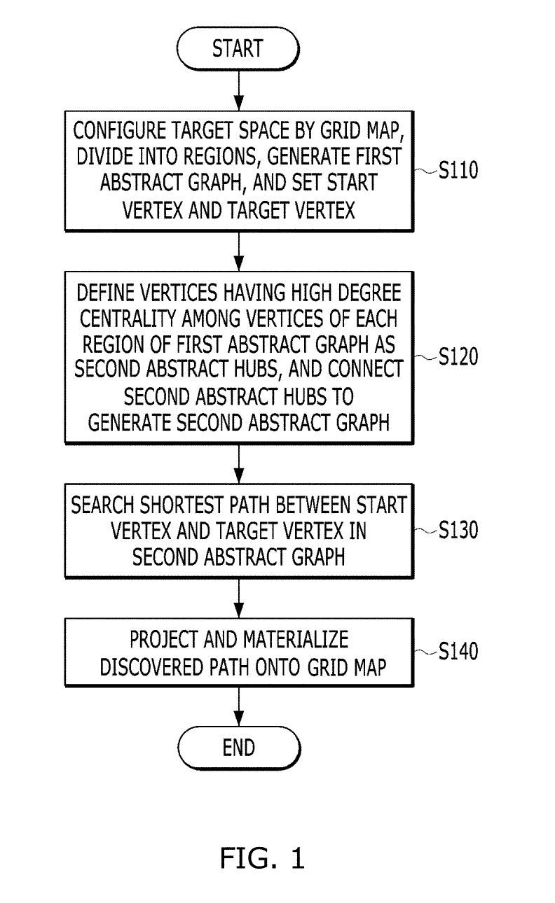

FIG. 1 is a flowchart of a hierarchical graph-based path search method according to the present invention. Referring to FIG. 1, the hierarchical graph-based path search method according to the present invention includes a first graph abstraction step S110, a second graph abstraction step S120, a graph search step S130, and a materialization step S140.

In the first graph abstraction step S110, a target space is configured by a grid map, the target space configured by the grid map is divided, and a start vertex and a target vertex are set in the grid map. First, the target space is constructed by a grid map structure and divided into regions of a certain size. In this case, the target space is not limited to any building or kind as long as it is only a physical space. For example, the target space may be a part of a building, a floor of a building, or an entire building if necessary. The start vertex may be a current position at which a user is located, and the target vertex may be a position to which a user wants to go. For example, when a dangerous situation occurs in the target space, the start vertex may be a current position at which the user is located, and the target vertex may be an exit to which the user can safely evacuate.

In addition, in the first graph abstraction step S110, a vertex of a divided region may be defined as a hub. In this case, the hub has the same meaning as a hub defined in social network analysis (SNA). Since the hub is not simply selecting an arbitrary point but connecting to a neighboring region through the corresponding vertex, a vertex having a greater connectivity than other vertices may be defined as the hub.

For example, when it is assumed that the entire target space consists of a 40×40 grid map, it is reconfigured into a set of 4×4 regions with a size of 10×10 to represent a map. In each region, a hub for connection to a neighboring region is configured, and the hub may define a vertex located at the center of each region unit as a basic hub. At this time, when an obstacle is located at the center of the region or when an obstacle completely surrounds the center, two or three auxiliary hubs may be defined. In this case, any one of auxiliary hubs in the corresponding region may replace the basic hub.

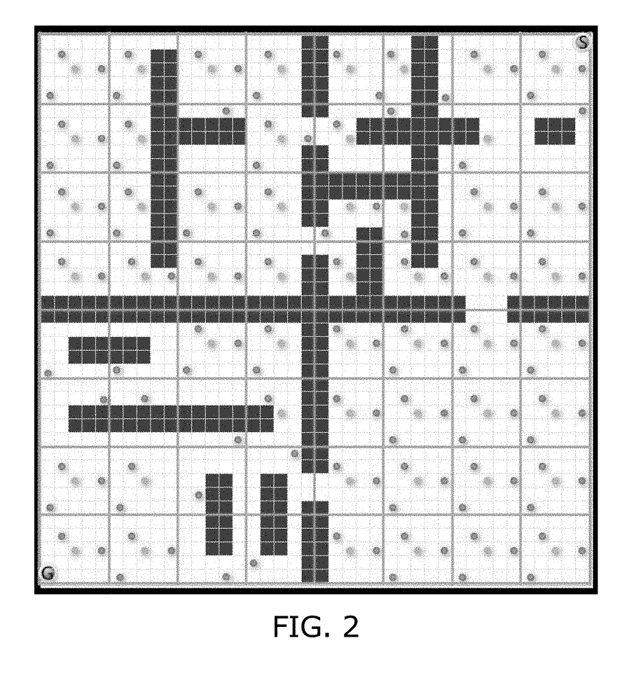

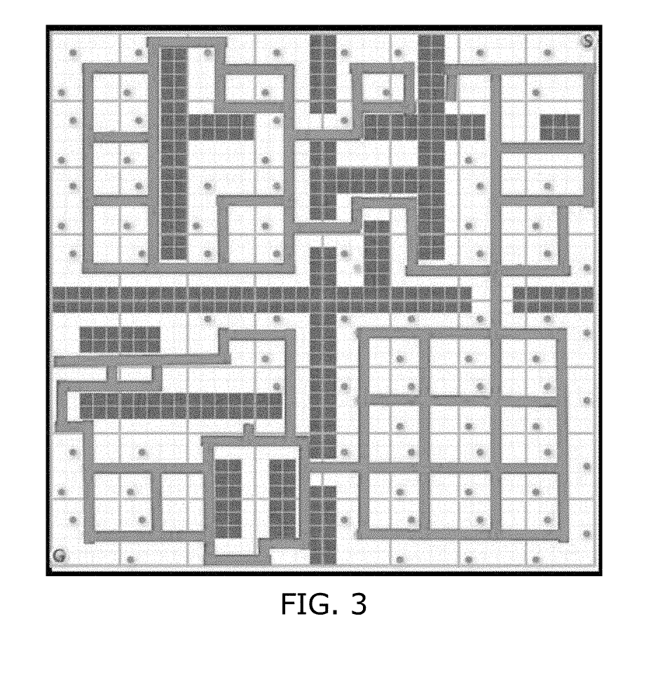

FIGS. 2 and FIG. 3 illustrate the first graph abstraction step according to an embodiment of the present invention. FIG. illustrates that the target space consists of a grid map having a size of 8×8 and is divided into regions. In addition, the vertex is arranged at the center of the region, and the vertices are arranged around the center vertex. The center vertex may be defined as the basic hub and the neighboring vertices may be defined as the auxiliary hub.

FIG. 3 illustrates that the basic hub or the auxiliary hub defined in each region of the grid map of FIG. 2 is connected to each other. As illustrated in FIG. 3, the basic hub or the auxiliary hub defined in each region is connected to each other, thereby completing the first graph generation.

In the second graph abstraction step S120, vertices having a high degree centrality among the vertices of each region of the first abstract graph generated in the first graph abstraction step S110 are defined as basic hubs, and the basic hubs are connected to generate a second abstract graph. Finding the vertices with high degree centrality may be extracted by an SNA technique.

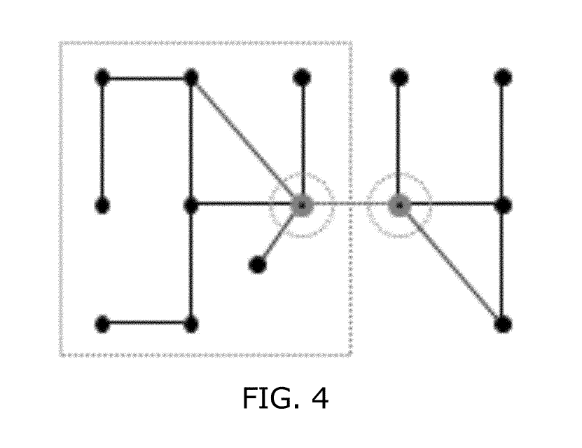

FIG. 4 is a diagram illustrating a second graph abstraction step according to an embodiment of the present invention. A second graph abstraction step S120 may be performed to generate a second abstract graph as illustrated in FIG. 4.

The first graph abstraction step S110 and the second graph abstraction step S120 may be repeatedly performed according to the size or complexity of the target space (the number of vertices, the arrangement of obstacles, and the number of obstacles). When the size of the target space is small or the complexity is low (when the number of vertices of the target space is small, the number of obstacles placed in the target space is small, or the arrangement of obstacles is simple), an abstract graph acquisition may be completed by performing the first graph abstraction step S110 and the second graph abstraction step S120 once. When the size of the target space is large or the complexity is high (the number of vertices of the target space is large, the number of obstacles placed in the target space is large, or the arrangement of obstacles is complicated), an abstract graph acquisition may be completed by repeating the first graph abstraction step S110 or the second graph abstraction step S120 several times. That is, the present invention may be regarded as having an n-th graph abstraction step according to the size or complexity of the target space.

Specifically, in the n-th graph abstraction step S140, after the second graph abstraction step, a vertex having high degree centrality among the vertices of each region of n-1 abstract graph is defined as an n-th basic hub (where n is an integer of 3 or more), and the n-th basic hub is connected to generate an n-th abstract graph, thereby completing the generation of an n-th abstract graph.

The graph search step S130 is a step of setting a start vertex and a target vertex on the second abstract graph generated in the second graph abstraction step S120 and searching for a shortest path between the start vertex and the target vertex. Since the shortest path is searched for in the abstracted graph, the time cost for searching for the shortest path may be minimized.

In the graph search step S130, the shortest path search may be performed by various algorithms. Among them, as an empirical search method based on the best-first search, an A* algorithm that uses a cost of moving so far and an estimated cost from a current position to a target position may be used to perform the shortest path search. In addition, as described above, the A* algorithm is one of the algorithms for searching for the shortest path, but the present invention may minimize the time cost when the shortest path is searched for by performing the A* algorithm on the abstracted graph.

In addition, various heuristics may be applied to the A* algorithm according to the method of developing the search region. The hierarchical graph-based path search method according to the present invention may further reduce the time cost by the following embodiments.

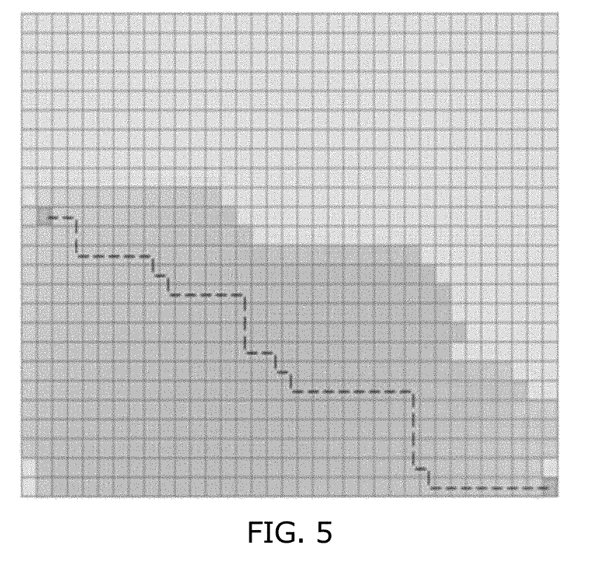

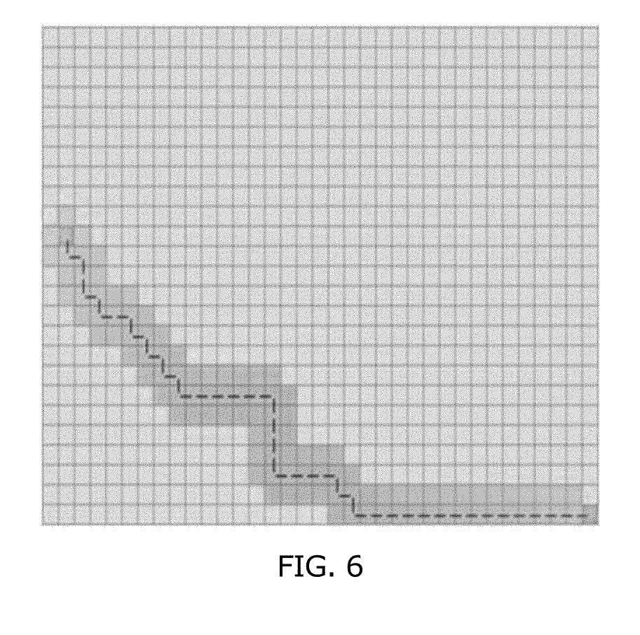

FIG. 5 is a diagram illustrating a search path and a region before applying ties-breaking in an A* algorithm, and FIG. 6 is a diagram illustrating a search path and a region after applying ties-breaking in an A* algorithm. If a basic diagonal distance heuristic is applied to the A* algorithm, the path search is performed in a wide range as illustrated in FIG. 5. The A* algorithm is generally defined as f(n)=g(n)+h(n), where f(n) is an evaluation function, g(n) is a path weight, and h(n) is an estimated path weight. In this case, unnecessary search regions may be reduced by applying the ties-breaking heuristic of removing the tie f(n) value when the f(n) value is obtained. FIG. 6 illustrates that the search region is reduced by removing the tie f(n) value and applying the A* algorithm. That is, the present invention may minimize the space actually searched for among the entire search target spaces by the above embodiment.

In addition, in the graph search step S130, the A* algorithm may be performed from the start vertex to the target vertex, and at the same time, the A* algorithm may be performed from the target vertex to the start vertex. That is, a bi-directional search may be performed between the start vertex and the target vertex. Such a bi-directional search may effectively reduce the search time under the same time and the same complexity. Even in the worst case, the same time cost as a unidirectional search is required.

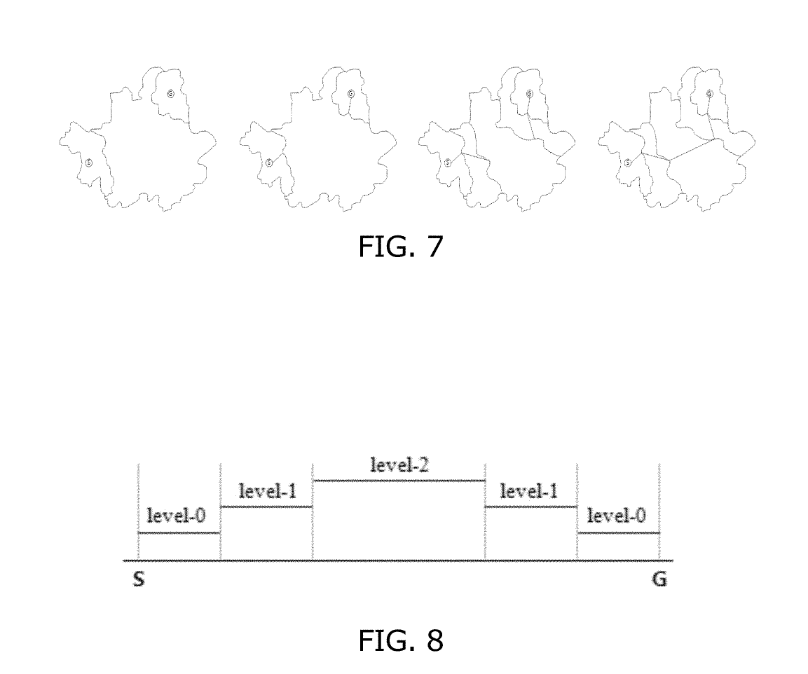

FIGS. 7 and 8 are diagrams illustrating a graph search step according to an embodiment of the present invention. In the graph search step according to the present invention, the search from the start vertex and the target vertex to the hub for escaping the initial region searches for the shortest path based on the first abstract graph, and the search for the next hub beyond the initial region may search for the shortest path with respect to the second abstract graph.

For example, if there is a start vertex in a certain region, the shortest path may be searched for with respect to the first abstract graph until escaping the region in which the start vertex is located, and the shortest path may be searched for with respect to the second abstract graph after escaping the corresponding region. At the same time, the shortest path may be searched for with respect to the first abstract graph until escaping the region in which the target vertex is located, and the shortest path may be searched for with respect to the second abstract graph after escaping the corresponding region.

Details thereof will be described with reference to FIGS. 7 and 8. In FIG. 7, S represents a start vertex and G represents a target vertex. In FIG. 8, level-0 represents a layer before abstraction, and level-1 represents a layer that generates a first abstract graph, and level-2 represents a layer that generates a second abstract graph {although not illustrated, it may include level-n (where n is an integer of 3 or more) according to complexity}. That is, in level-0, the search is performed for connection from the start vertex to the boarder that is in contact with the neighboring region in a state before the abstract graph is generated. In level-1, the shortest path is searched for with respect to the first abstract graph. In level-2, the shortest path is searched for with respect to the second abstract graph.

As an example for the sake of understanding, if a person moves from Seoul to Busan, it is similar to a series of steps of i) walking to a near bus stop, (ii) taking a bus to Seoul Station, (iii) arriving at Busan Station by train, iv) moving to a bus stop near a destination by bus, and finally v) getting off at a bus stop and walking to a destination.

That is, when the path search is compared to the movement of a person, it can be regarded as an abstraction (abstraction step) that a person uses a moving means such as an automobile. In other words, a person's direct walking movement may be regarded as a layer before abstraction, and a person's use of a moving means may be regarded as an abstraction layer.

When substituting into the previous example, i) moving to a near bus stop and v) getting off at a bus stop and walking to a destination may be regarded as level-0 because a person directly walks and moves, ii) taking a bus to Seoul Station and iv) moving to a bus stop near a destination by bus may be regarded as level-1 because a person uses a bus as a moving means, and iii) arriving at Busan Station by train may be regarded as level-2 because a person uses a train as a moving means.

In this way, the search from the start vertex and the target vertex to the hub for escaping the initial region is performed with respect to the initial graph, and in an intermediate process, all graphs are not searched for and only vertices constituting connection between regions are searched for. Therefore, the effect of reducing the search region may be achieved, and more effective search may be performed.

The above-described method of searching for the shortest path according to the hierarchical path by abstracting the map may enable an efficient operation of a search region. However, when the two hierarchically separated regions are located as the neighboring regions, searching for the path using the abstracted graph may cause a rather high time cost. In order to prevent occurrence of such a time cost, when the start vertex and the target vertex are located in the mutually neighboring regions, the present invention can directly search for the shortest path between the two vertices, without using the abstract graph. This makes it possible to effectively acquire the shortest path even when the start vertex and the target vertex are located in the mutually neighboring regions.

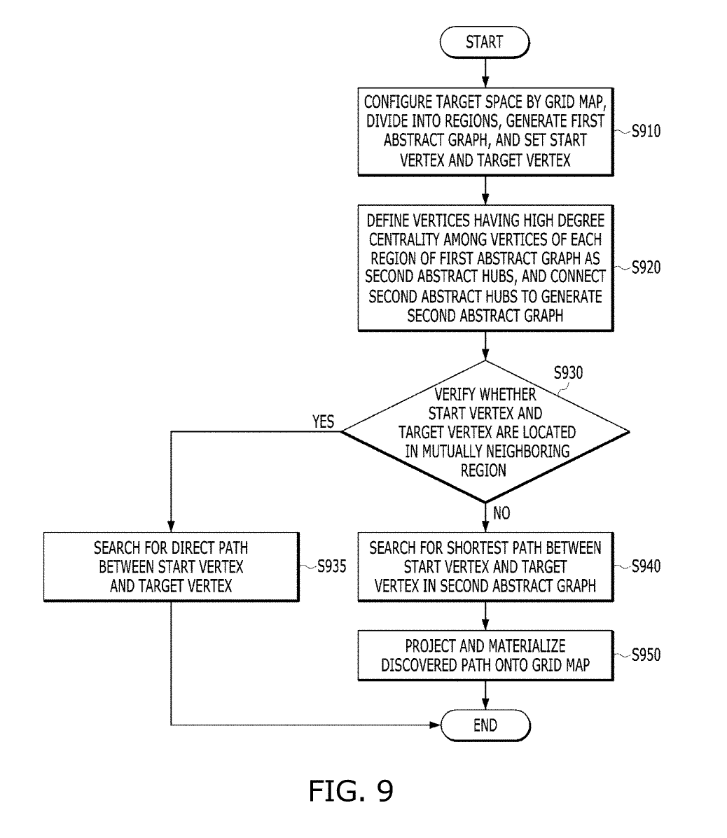

FIG. 9 is a diagram illustrating a procedure of a hierarchical graph-based path search method according to another embodiment of the present invention. The hierarchical graph-based path search method according to the present invention may further include a verification step of verifying whether the start vertex and the target vertex are located in the mutually neighboring regions before the graph search step S940. When the start vertex and the target vertex are located in the mutually neighboring regions, a direct path between the start vertex and the target vertex may be searched for in the graph search step S935. That is, according to an embodiment of the present invention, when the start vertex and the target vertex are not located in the mutually neighboring regions, the map is abstracted to search for the shortest path along the hierarchical path, and when the start vertex and the target vertex are located in the mutually neighboring regions, the shortest path is not searched for along the hierarchical path and a direct path search is performed. Therefore, the shortest path may be acquired while minimizing the time cost.

The materialization step S140 is a step of projecting and materializing the shortest path searched for (acquired) in the graph search step S130 onto a grid map configured in the first graph abstraction step. When the shortest path corresponds to the grid map of the corresponding lowest hierarchical layer in each region, a moving path for the initial grid map cached in the process of generating the abstract graph, if any, is referred to. However, if there is no cached path, a path search is performed between the two vertices (hubs) of the corresponding region. The materialization step S140 may be performed in units of regions to acquire the shortest path in the divided region.

As described above, if using the hierarchical graph-based path search method, the shortest path from the start vertex to the target vertex may be acquired while minimizing time cost and minimizing data throughput.

The path search method in the IoT environment using the hierarchical graph-based path search method according to the present invention is based on the premise that it is configured to include two layers, that is, the IoT layer and the server layer. The IoT layer may be configured to include a plurality of sensors, and the plurality of sensors may be configured to communicate with one another. In addition, the IoT layer is configured to communicate with the server layer through the gateway. At this time, the server layer includes at least one server, and it is preferable that the server layer is connected to the Internet network.

In addition, the server layer may be configured in a cloud environment and may be configured to include a data storage and a crawler that collects logical environmental information (external data such as weather information or the like). The server layer has better computing capability than the IoT, thus enabling a large amount of data processing or advanced computation.

The IoT layer can enable the plurality of sensors to generate context information, transmit and receive the generated context information among the plurality of sensors or transmit the generated context information to the server layer, and the server layer can perform a predetermined computing process and transmit the processing result to the IoT layer (the plurality of sensors). Since the IoT layer has less computing capability than the server layer, it is preferable that a large amount of data processing or advanced computation is performed at the server layer rather than the IoT layer.

In the path search method in the IoT environment using the hierarchical graph-based path search method according to the present invention, the space in which the IoT layer is formed is the target space. The IoT layer may collect context information from the target space in real time and transmit the collected context information to the server layer, and the server layer may search for the shortest path and provide the shortest path to the user. In this case, the shortest path may use the hierarchical graph-based path search method described with reference to FIGS. 1 to 9 or a hierarchical graph-based path search method described in claims 1 to 5. In addition, the start vertex at this time may be a current position at which a user is located, and the target vertex may be an entrance or an emergency exit at which the user can enter from and exit to the outside.

The path search method in the IoT environment using the graph-based path search method according to the present invention may minimize the time cost in the IoT environment and effectively provide the shortest path to the user.

In particular, when providing the shortest path to the user in the IoT environment, it is necessary to consider dangerous situations. Examples of dangerous situations are fire, earthquake, and terrorism. The dangerous situations are not limited to these examples, and the situation in which the user is urgently evacuated may be regarded as the dangerous situations. Since the user must urgently evacuate in these dangerous situations, it is necessary to be able to search for the shortest path from the current position at which the user is located to the safe place and guide (escort) the user as quickly as possible. The shortest path can be searched for as fast as possible by using the graph-based path search method described above, and the user can be guided to the discovered shortest path.

In addition, in the dangerous situations, it should be possible to change the shortest path in real time and provide the changed shortest path to the user. In the case of a fire, for example, the fire may cause the structure of the target space to collapse or cause poisonous gas to be generated, and it will be dangerous for the user to move to the place where the structure collapses or the poisonous gas is generated. If the structure collapses or the poisonous gas is generated on the shortest path where the place at which the user can safely evacuate is the target vertex, a safe shortest path should be re-searched for and the user should be guided to the newly discovered shortest path.

In the path search method in the IoT environment using the graph-based path search method according to the present invention, the IoT layer collects context information from the target space in real time and recognizes occurrence of an obstacle on the shortest path (as in the above example, fire causes the structure to collapse or causes the poisonous gas to be generated) (the recognized information can be included in context information collected by the IoT layer), and the server layer may receive the context information and determine whether an obstacle occurs on the shortest path. If the server layer determines that an obstacle has occurred on the shortest path, a new shortest path may be searched for and transmitted to the IoT layer, so that the new shortest path is provided to the user.

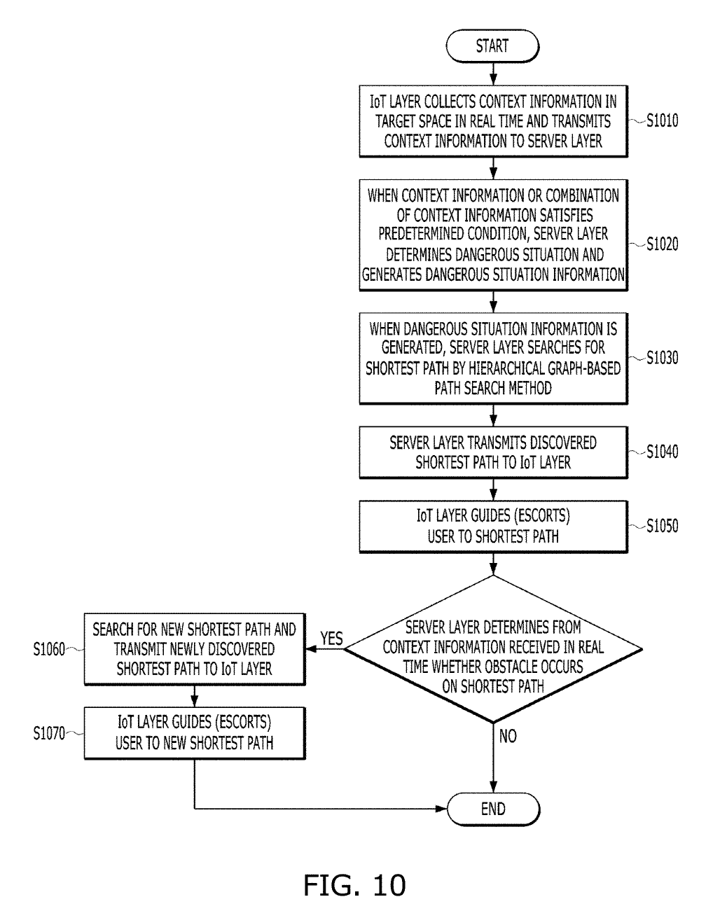

FIG. 10 is a diagram illustrating a procedure of a path search method in an IoT environment using a hierarchical graph-based path search method according to the present invention. A case where, when a dangerous situation such as a fire occurs, a shortest path is searched for and guided to a user will be described in detail with reference to FIG. 10.

A path search method in an IoT environment using a hierarchical graph-based path search method according to an embodiment of the present invention may include: a context information collection step S1010 of collecting, by an IoT layer, context information in real time and transmitting the context information to a server layer; a dangerous situation information generation step S1020 of, when the context information received by the IoT layer or a combination of the received context information satisfies a predetermined condition, determining a dangerous situation and generating dangerous situation information; a path search step S1030 of, when the dangerous situation information is generated, searching for a shortest path by a hierarchical graph-based path search method; a shortest path transmission step S1040 of transmitting, by the server layer, the discovered shortest path to the IoT layer; and a path guide step S1050 of, when the IoT layer receives the shortest path, guiding (escorting) the user to the shortest path by using devices constituting the IoT layer.

In addition, the path search method in the IoT environment using the hierarchical graph-based path search method according to the present invention may further include, after the path guide step S1050: a path re-search step S1060 of, when the server layer determines from the context information received in real time that an obstacle occurs on the shortest path, searching for a new shortest path and transmitting the newly discovered shortest path to the IoT layer; and a new shortest path guide step S1070 of guiding, by the IoT layer, the user to the new shortest path.

The context information collection step S1010 is a step in which the IoT layer collects context information in the target space in real time. Where the IoT layer includes a plurality of sensors, the plurality of sensors may sense predetermined data and generate context information based on the sensed data.

In this manner, the context information may be collected. For example, where the IoT layer includes a plurality of temperature sensors, the plurality of temperature sensors may acquire temperature data by measuring an ambient temperature and generate context information based on the temperature data. The temperature data itself may be context information. That is, in the context information collection step S1010, the IoT layer normally collects the context information in the target space.

In the dangerous situation information generation step S1020, when the context information received from the IoT layer or a combination of the received context information satisfies a predetermined condition, the server layer may determine that it is the dangerous situation, generate dangerous situation information, and transmit the dangerous situation information to the IoT layer. At this time, for example, the predetermined condition may be that, in a region of the IoT layer including a temperature sensor, a lighting device, and an illumination sensor, the temperature sensor continuously generates context information on the temperature rise, the lighting device generates context information with respect to power off, and the illumination sensor generates context information with respect to brightness. When the temperature sensor continuously generates the context information on the temperature rise, the lighting device generates the context information with respect to power off, and the illumination sensor generates the context information with respect to brightness, it may be determined that the fire occurred in that region. The present invention is not limited to this example, and various conditions may be set by variously combining the sensors constituting the IoT layer.

The path search step S1030 is a step in which the server layer searches for the shortest path, and the shortest path may be searched for by using the hierarchical graph-based path search method described above.

The path guide step S1050 is a step of, when the IoT layer receives the shortest path, guiding (escorting) the user to the shortest path by using the devices constituting the IoT layer. The IoT layer may include the lighting device, and the shortest path may be guided (escorted) to the user by flickering or color change of the lighting device on the shortest path searched for in the path search step. In this manner, it is possible to provide the user with an efficient service (a service that notifies the user of the shortest path in case of fire) in the IoT environment.

The path re-search step S1060 is a step of searching for a new shortest path and transmitting the newly discovered shortest path to the IoT layer, where it is determined from the context information received in real time by the server layer that an obstacle has occurred on the shortest path. The new shortest path guide step S1070 is a step in which the IoT layer guides the user to a new shortest path. The IoT layer may further include a gas sensor for detecting generation of poisonous gas. In this configuration, the IoT layer may detect the generation of poisonous gas from the gas sensor in a middle region of the shortest path while guiding (escorting) the user to the shortest path. At this time, the IoT device having detected the generation of gas may mark (store) its own position as a region (obstacle) in which the users cannot move, and notify front/rear IoT devices on the shortest path of its position as a region in which they cannot move.

That is, in the path search method in the IoT environment using the hierarchical graph-based path search method according to the present invention, the IoT devices may share, in real time, the fact that the current shortest path is not a shortest path to a safe region due to the obstacle newly occurred, the shortest path may be newly set based on this, and the new shortest path may be guided (escorted) to the user.

As described above, the hierarchical graph-based path search method according to the present invention can improve efficiency while minimizing time cost by abstracting the graph hierarchically and searching for the shortest path in the abstract graph. In addition, the path search method in the IoT environment using the hierarchical graph-based path search method can also improve efficiency while minimizing time cost by abstracting the graph hierarchically and searching for the shortest path in the abstract graph, thereby guiding the user to the shortest path as soon as possible.

In the foregoing descriptions, although the present invention has been described in connection with the specific matters, such as the specific components, the specific embodiments, and the drawings, they are provided only for assisting in the understanding of the present invention, and the present invention is not limited to the embodiments. It will be apparent that those skilled in the art can make various modifications and changes thereto from these descriptions.

Therefore, the spirit of the present invention should not be limited to the aforementioned embodiments, and the appended claims and what are modified equally or equivalently thereto will be considered to fall within the scopes of the present invention.

1. A hierarchical graph-based path search method comprising:
a first graph abstraction step of configuring a target space by a grid map and dividing the target space into regions to set a start vertex and a target vertex, and generating a first abstract graph by defining each vertex of the divided region as a basic hub;
a second graph abstraction step of defining vertices having a high degree centrality among vertices of each region of the first abstract graph as second basic hubs and generating a second abstract graph by connecting the second basic hubs;
a graph search step of searching a shortest path between the start vertex and the target vertex in the second abstract graph; and
a materialization step of projecting and materializing the path discovered in the graph search step onto the grid map.

2. The hierarchical graph-based path search method of claim 1, further comprising, after the second graph abstraction step, an n-th graph abstraction step, where n is an integer of 3 or more, of defining vertex having a high degree centrality among the vertices of each region of n-1 abstract graph as n-th basic hubs, and generating an n-th abstract graph by connecting the n-th basic hubs,
wherein the graph search step sets the start vertex and the target vertex in the n-th abstract graph and searches for a shortest path between the start vertex and the target vertex.

3. The hierarchical graph-based path search method of claim 1, wherein
a search for escaping an initial region in which the start vertex and the target vertex are located is performed by searching for a shortest path with respect to the first abstract graph, and a search after escaping the initial region is performed by searching for the shortest path with respect to the second abstract graph.

4. The hierarchical graph-based path search method of claim 1, further comprising, before the graph search step, a verification step of verifying whether the start vertex and the target vertex are located in a mutually neighboring region,
wherein, when the start vertex and the target vertex are located in the mutually neighboring region, a direct path between the start vertex and the target vertex is searched for.

5. The hierarchical graph-based path search method of claim 1, wherein the graph search step comprises searching for a shortest path by using a predetermined algorithm, and
the predetermined algorithm is performed from the start vertex to the target vertex, and at the same time, the predetermined algorithm is performed from the target vertex to the start vertex.

6. A path search method in an Internet of Things (IoT) environment using the hierarchical graph-based path search method of claim 1, wherein
the IoT environment comprises an IoT layer and a server layer, and the server layer searches for a shortest path by using the hierarchical graph-based path search method.

7. The path search method of claim 6, comprising:
a context information collection step of collecting, by the IoT layer, context information in the target space in real time and transmitting the collected context information to the server layer;
a dangerous situation information generation step of determining, by the server layer, a current situation as a dangerous situation when the received context information or a combination of the received context information satisfies a predetermined condition, and generating dangerous situation information;
a path search step of, when the dangerous situation information is generated, searching for the shortest path by using the hierarchical graph-based path search method;
a shortest path transmission step of transmitting, by the server layer, the discovered shortest path to the IoT layer; and
a path guide step of, when the IoT layer receives the shortest path, guiding a user to the shortest path by using devices constituting the IoT.

8. The path search method of claim 7, further comprising, after the path guide step:
a path re-search step of searching for a new shortest path when the server layer determines from the received context information that an obstacle occurs on the shortest path, and transmitting the newly discovered shortest path to the IoT layer; and
a new shortest path guide step of guiding, by the IoT layer, the user to the new shortest path.

9. The path search method of claim 7, wherein the IoT layer comprises a lighting device, and the path guide step comprises guiding the user to the shortest path by flickering or color change of the lighting device on the shortest path.

10. The hierarchical graph-based path search method of claim 2, wherein
a search for escaping an initial region in which the start vertex and the target vertex are located is performed by searching for a shortest path with respect to the first abstract graph, and a search after escaping the initial region is performed by searching for the shortest path with respect to the n-th abstract graph.
